(19) United States
(12) Patent Application Publication
(10) Pub. No.: US 2003/0027600 A1
(43) Pub. Date: Feb. 6, 2003

(54) Microphone antenna array using voice activity detection

(76) Inventors: Leonid Krasny, Cary, NC (US); Sootorn Oraintara, Boston, MA (US)

Correspondence Address: MOORE & VAN ALLEN, PLLC, 2200 W MAIN STREET, SUITE 800, DURHAM, NC, 27705, US

(21) Appl. No.: 09/851,787

(22) Filed: May 9, 2001

(51) Int. Cl. H04M 1/00

(52) U.S. Cl. 455/564; 455/550

(57) ABSTRACT

A noise reducing audio receiving system comprises a microphone array with a plurality of microphone elements for receiving an audio signal. An array filter is connected to the microphone array for filtering noise in accordance with select filter coefficients to develop an estimate of a speech signal. A voice activity detector is connected to the microphone array and comprises a beamformer for combining audio from the microphone elements and a detector for detecting presence or absence of speech in the combined audio. A correlation estimator is operatively connected to the microphone array, the voice activity detector and the array filter. The correlation estimator updates the select filter coefficients using the received audio signal in the absence of speech in the received audio signal.

### BACKGROUND OF THE INVENTION

The present invention is directed to providing noise reduction and, more particularly, to apparatus and method for providing noise reduction for a signal received at a microphone antenna array.

Mobile terminals, such as cellular telephones, have increased in popularity and become a part of everyday human life. Conversations using mobile terminals often take place in an automobile when a user is traveling. Hands-free operation has been introduced for safety purposes. In an automobile environment, the speech signal is often corrupted by noise which complicates and degrades the speech coding.

Current hands-free mobile terminal systems use a single microphone as a receiver to a noise reduction algorithm. The algorithm typically uses the difference between spectral properties of the signals of interest, i. e., the speech signal, and noise. Spectral subtraction may be used. Spectral subtraction is done in the frequency domain taking advantage of the convolutional property and the efficient implementation of the fast Fourier transform. However, in human conversation, speech signals are not present at all times. During the time that there is no speech signal, the noise can be immediately suppressed. In any spectral subtraction algorithm, both speech signals and noise spectra are necessary to construct a noise reduction filter, but there is only a combined signal available.

In automobile environments, or other closed environments, the speech signal from the talker's mouth and environmental noise from the automobile engine, windshield, side windows and other sources possess different spatial properties. Instead of utilizing the difference in the frequency spectra between the speech signal and the noise, spatial properties of the signals can be taken into account. This can be accomplished by using a microphone antenna array. Using a microphone antenna array requires use of an array filter. The filter uses a noise spatial correlation matrix. In conventional array processing, the correlation matrix is estimated without knowing that a current received signal is composed of speech signal and noise or noise only.

### SUMMARY OF THE INVENTION

In accordance with the invention, an audio receiving system including a microphone array uses a voice activity detector.

Broadly, there is disclosed herein a noise reducing audio receiving system comprising a microphone array comprising a plurality of microphone elements for receiving an audio signal. An array filter is connected to the microphone array for filtering noise in accordance with select filter coefficients to develop an estimate of a speech signal. A voice activity detector is connected to the microphone array and comprises a beamformer for combining audio from the microphone elements and a detector for detecting presence or absence of speech in the combined audio. A correlation estimator is operatively connected to the microphone array, the voice activity detector and the array filter. The correlation estimator updates the select filter coefficients using the received audio signal in the absence of speech in the received audio signal.

Further features and advantages of the invention will be readily apparent from the specification and from the drawings.

### BRIEF DESCRIPTION OF THE DRAWINGS

FIG. 1 is a generalized block diagram of a mobile terminal used in a mobile communications system and including a noise reducing audio receiving system in accordance with the invention;

FIG. 2 is a block diagram of the noise reducing audio receiving system in accordance with a first embodiment of the invention;

FIG. 3 is a flow diagram illustrating implementation of the noise reducing audio receiving system of FIG. 2;

FIG. 4 is a block diagram of the noise reducing audio receiving system in accordance with a second embodiment of the invention; and

FIG. 5 is a flow diagram illustrating implementation of the noise reducing audio receiving system of FIG. 4.

### DETAILED DESCRIPTION OF THE INVENTION

The present invention relates to a method and apparatus for reducing noise with a microphone array, also referred to as an antenna array, in a small enclosure such as a automobile cabin or teleconference room, or the like. This method and apparatus may be useful in, for example, hands-free mobile terminals and speech recognition systems for vehicles and incorporates a voice activity detector (VAD) and array processing to accurately estimate a correlation matrix of the noise field at the array receivers. Two types of VAD for array processing are utilized. The first uses single channel noise reduction. The received signals at the microphone antenna array are combined using conventional beamforming and fed into a single channel VAD. The second implementation updates beamforming coefficients.

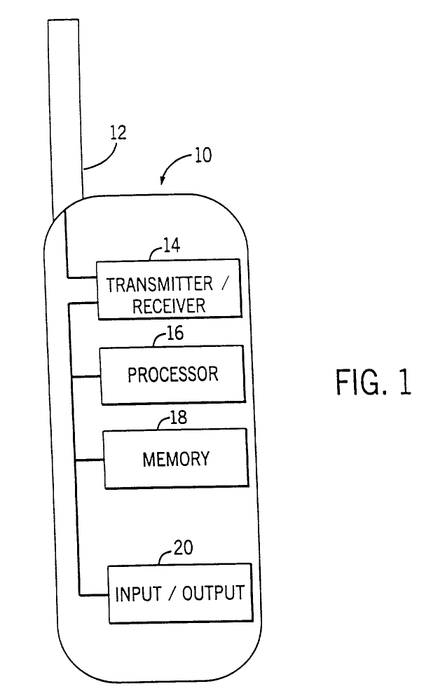

FIG. 1 illustrates a typical mobile terminal in 10 including an antenna 12 for sending and receiving radio signals between itself and a radio communications network, such as a mobile communications system. The antenna 12 is connected to a transmitter/receiver circuit 14 to transmit radio signals to the network and likewise receive radio signals from the network. A programmable processor 16 controls and coordinates the functioning of the mobile terminal 10 responsive to messages on a control channel using programs and data stored in a memory 18. The processor 16 also controls operation of the mobile terminal 10 responsive to input from an input/output circuit 20. The input/output circuit 20 may consist of a keypad as a user input device, a display to give the user information and a speaker. In accordance with the invention. The input/output circuit 20 also includes a microphone array for receiving an audio signal.

The present invention is described herein in the context of a mobile terminal. As used herein, the term “mobile terminal” may include a mobile communications radiotelephone with or without a multi-line display; a Personal Communications System (PCS) terminal that may combine a mobile communications radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

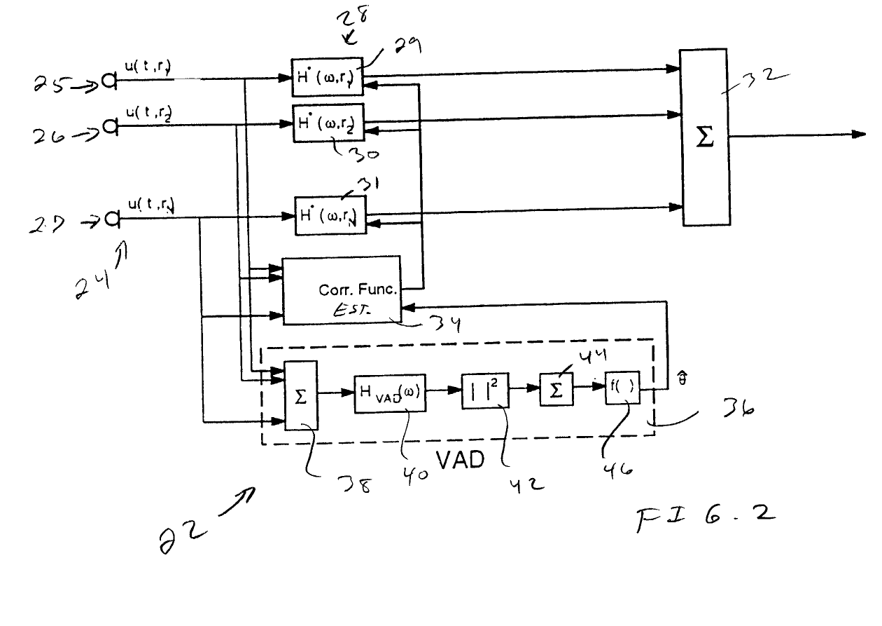

Referring to FIG. 2, a block diagram illustrates an audio receiving system or apparatus 22, implemented in the mobile terminal 10 of FIG. 1, providing for noise reduction in accordance with the invention. As will be apparent, the noise reducing audio receiving system 22 could be used in other devices such as, for example, speech recognition systems. Individual blocks of the block diagram of FIG. 2 may be implemented in any one of the transmitter/receiver circuit 14, processor 16 or input/output circuit 20 of the mobile terminal of FIG. 1. Where the functionality of the individual blocks is implemented is dependent upon the particular design of the mobile terminal 10.

A microphone array 24 includes a plurality N of microphone elements, for example microphone elements 25, 26 and 27. A mixtured field u(t,r) is a superposition between two fields, namely a speech signal field s(t, r) and a noise field n(t, r) where r is a vector indicating the spatial coordinate for the field. In FIG. 2, r₁, r₂ and r_{N} are the spatial coordinates of the respective microphone elements 25, 26 and 27. The microphone array 24 is connected to an array filter 28. The array filter includes individual filters 29, 30 and 31 connected to respective microphone elements 25, 26 and 27. Each filter 29-31 in the array 28 is represented by H(ω, rᵢ). The filtered signals are provided to a summer 32 which supplies an estimate of a speech signal as the superposition of the signal outputs from the array filters, i. e.,

$$\hat{S} ( ω ) = {\sum }_{i = 1}^{N} U ( ω , {r}_{i} ) {H}^{*} ( ω , {r}_{i} ) , \qquad [ 1 ]$$

where U(ω, rᵢ) and Ŝ(ω) are the Fourier transforms of the field u(t, rᵢ) and signal estimate ŝ(t) respectively.

The optimal filter can be given by [2]

$$\begin{matrix}H ( ω , {r}_{i} ) = \frac{{H}_{0} ( ω , {r}_{i} )}{{\sum }_{i = 1}^{N} G ( ω ; {r}_{i} , {r}_{0} ) {H}_{0}^{*} ( ω , {r}_{i} )} , where & [ 2 ] \\ {H}_{0} ( ω , {r}_{i} ) = {\sum }_{p = 1}^{N} {K}_{N}^{- 1} ( ω ; {r}_{i} , {r}_{p} ) G ( ω ; {r}_{p} , {r}_{0} ) & [ 3 ]\end{matrix}$$

K_{N}⁻¹(ω; rᵢ, rₚ) denotes the elements of the matrix K_{N}⁻¹(ω) which is the inverse of the noise spatial correlation matrix K_{N}(ω) with the elements K_{N}(ω;rᵢ,rₚ), and G(ω; rᵢ, r₀) is the Green function which describes the propagation channel between the talker with the spatial correlation r₀ and i-th array microphone.

Equation [3] requires only the noise spatial correlation matrix. When speech is present, the correlation matrix contains both correlations of a speech signal and noise. In accordance with the invention, the noise spatial correlation matrix is updated only during time frames that a speech signal is absent. Particularly, a correlation function estimator 34 is connected to the microphone array 24 and the filter array 20 and is adapted to update filter coefficients using the audio signal received at the microphone array 24 in the absence of speech as determined by a voice activity detector (VAD) 36.

The VAD 36 includes a beamformer 38 which assumes that the incident speech field is a plain wave with spatially uncorrelated noise field. The beamformer 38 develops a summation of the received signals:

$$u ( n ) = \frac{1}{N} {\sum }_{i = 1}^{N} u ( n , {r}_{i} ) . \qquad [ 4 ]$$

An output signal from the beamformer 38 is filtered by a VAD filter 40 having a frequency response H_{VAD}(ω). Particularly, the filter output is represented by

$$v ( n ) = {\sum }_{i = 0}^{L} b ( i ) \cdot u ( n - i ) , \qquad [ 5 ]$$

where b(i) are the VAD filter's coefficients. The filter output is squared and summed

$${U}_{VAD} ( q ) = \frac{1}{{N}_{0}} {\sum }_{n = ( q - 1 ) {N}_{0}}^{{qN}_{0} - 1} {v}^{2} ( n ) . \qquad [ 6 ]$$

A function block 46 detects for presence or absence of speech in the combined audio in accordance with the following:

$$\hat{θ} ≡ f \{ {U}_{VAD} ( q ) \} = \{ \begin{matrix}1 , if {U}_{VAD} ( q ) > Tr ( q ) \\ 0 , otherwise ,\end{matrix} \qquad [ 7 ]$$

The output of the VAD 36 controls whether or not the correlation function estimator 34 should be updated. Particularly, in the absence of speech, the correlation function estimator 34 updates filter coefficients for the array filter 28 by developing a noise spatial correlation matrix, as described above, for calculating the filter coefficients using equation [2].

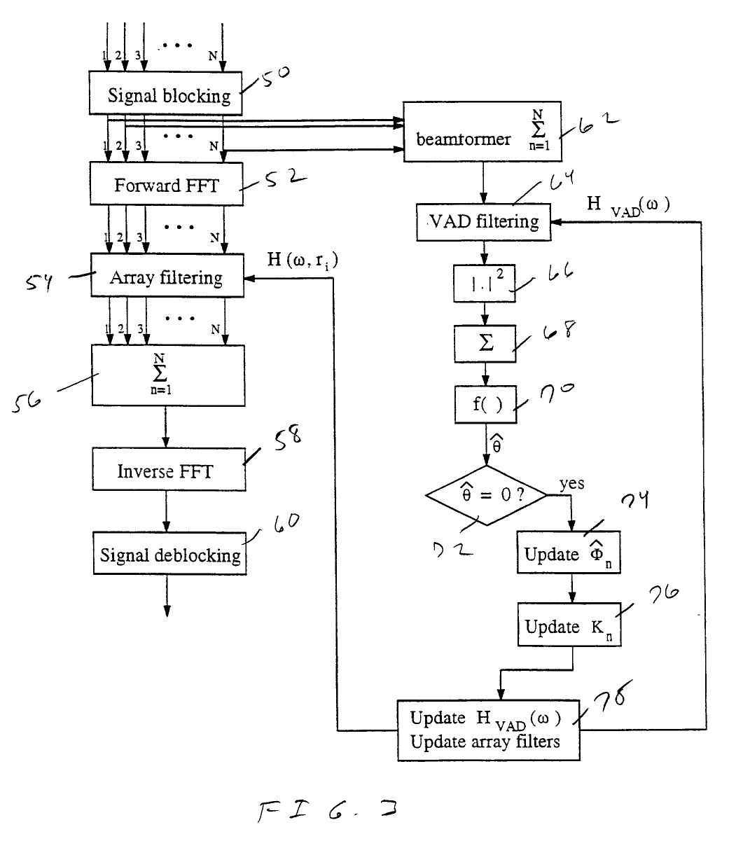

FIG. 3 illustrates a flow chart for array processing using the voice activity detector 36 of FIG. 2. A block 50 receives the plurality of audio signals from the microphone array 24. A block 52 implements a forward fast Fourier transform (FFT) for converting the audio signals to the frequency domain. A block 54 implements the array filtering function using the filtering coefficients H(ω, rᵢ). A block 56 sums the filtered signals to provide the estimated speech signals and a block 58 forms an inverse FFT to transform the estimated speech signal back to the time domain and a block 60 implements signal deblocking.

In parallel, a processing block 62 provides for beamforming by summing the audio signals from the block 50. A block 64 performs the VAD filtering using the filter H_{VAD}(ω). Blocks 66 and 68 square and sum the filter output. A block 70 implements the function of equation [7]. To determine the VAD output, a decision block 72 determines the presence or absence of speech by determining whether the function output is above or below a select level. If zero, indicating the absence of speech, then a block 74 updates an estimate of the noise PSD. This may be calculated using equation [10], below. The noise spatial correlation matrix is updated at a block 76. A block 78 updates the array filter 28 and the VAD filter 40 by feeding the filter coefficients back to the respective blocks 54 and 64.

In the approach described in connection with FIGS. 2 and 3, the beamformer for the VAD 36 is fixed.

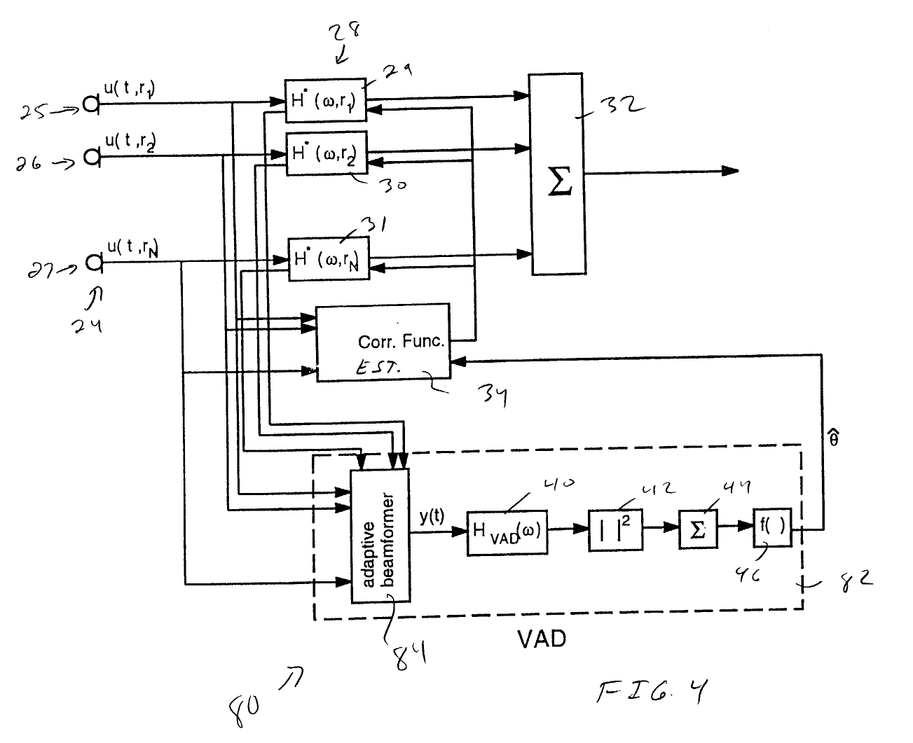

In accordance with a second embodiment of the invention, filter coefficients at the beamformer for the VAD are adapted accordingly as well as those for the matched field filters to improve signal-to-noise ratio (SNR). FIG. 4 illustrates an audio receiving system 80 in accordance with a second embodiment of the invention including an adaptive voice activity detector (VAD) 82. The noise reducing audio receiving system 80 of FIG. 4 is overall generally similar to the system 22 of FIG. 2. Individual elements common to both are referenced with like reference numerals and are not described in detail herein relative to FIG. 4. The noise reduction system 80 of FIG. 4 differs primarily in utilizing an adaptive beamformer 84 in the adaptive VAD 82. The adaptive VAD 82 takes the noise reduction filters used for array processing as a beamformer. The output of the adaptive beamforner 84 is described by

$${Y}_{q} ( k ) = {\sum }_{i = 1}^{N} {U}_{q} ( k , {r}_{i} ) {H}_{q - 1}^{*} ( k , {r}_{i} ) , \qquad [ 8 ]$$

where, in this case U_{q}(k, rᵢ,) are the Fourier transforms of the signal inputs u(t, rᵢ) at the current q-th time frame, and H_{q-1}(k, rᵢ) are the frequency responses of the array filters obtained from the previous (q−1)-th frame.

The VAD output is described by the equation

$${U}_{VAD} ( q ) = \frac{2}{{N}_{0} + 2} {\sum }_{k = 0}^{{N}_{0} / 2} \frac{{\vert {Y}_{q} ( k ) \vert}^{2}}{{\hat{Φ}}_{nq} ( k )} , \qquad [ 9 ]$$

where \hat{Φ}_{nq}(k) is an estimate of the noise Power Spectral Density (PSD) at the beamformer output. This estimate can be calculated using a conventional Least Mean Square (LMS) algorithm

$${\hat{Φ}}_{nq} ( k ) = m \cdot {\hat{Φ}}_{n ( q - 1 )} ( k ) + ( 1 - m ) \cdot {\vert {Y}_{q} ( k ) \vert}^{2} , \qquad [ 10 ]$$

where m is a convergence factor.

The adaptive beamformer 84 reduces the noise level after array processing and therefore improves the SNR at the output of the VAD 82. In accordance with the invention, the adaptive beamformer 84 uses the same filter coefficients as the array processing by the filter array 28.

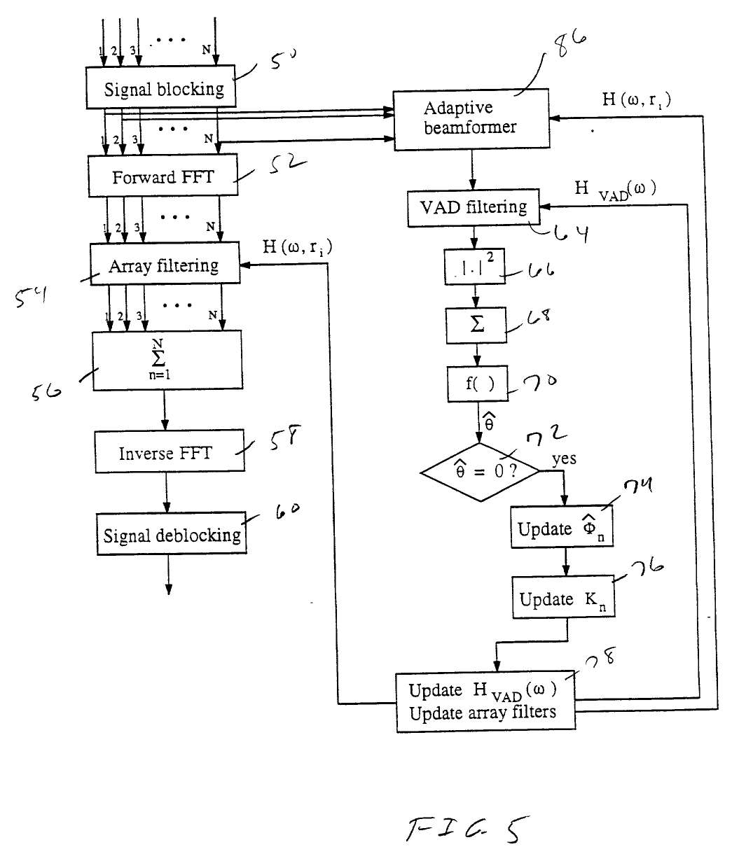

FIG. 5 is a flow diagram illustrating a method of reducing noise in the audio receiving system 80 of FIG. 4. In general, the flow diagram of FIG. 5 is similar to the flow diagram of FIG. 3 and similar blocks are identified with similar reference numerals. The principal difference is that the block 62 of FIG. 3 is replaced with a block 86 implementing an adaptive beamformer function, as discussed above. Moreover, the block 78 is connected to the block 86 so that when the array filters in the block 54 are updated, the same coefficients are used for updating the adaptive beamformer function in the block 86.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

Thus, in accordance with the invention, an audio receiving system includes a microphone antenna array and uses a voice activity detector to provide improved array processing.

We claim:

1. A noise reducing audio receiving system comprising:
a microphone array comprising a plurality of microphone elements for receiving an audio signal;
an array filter connected to the microphone array for filtering noise in accordance with select filter coefficients to develop an estimate of a speech signal;
a voice activity detector connected to the microphone array and comprising a beamformer for combining audio from the microphone elements and a detector for detecting presence or absence of speech in the combined audio;
a correlation estimator operatively connected to the microphone array, the voice activity detector and the array filter, the correlation estimator updating the select filter coefficients using the received audio signal in the absence of speech in the received audio signal.

2. The noise reducing audio receiving system of claim 1 wherein the array filter comprises a filter for each microphone element and a summer and the speech signal estimate is a superposition of signal outputs from the filters.

3. The noise reducing audio receiving system of claim 1 wherein the beamformer comprises a summer for summing signals from each of the microphone elements.

4. The noise reducing audio receiving system of claim 3 wherein the voice activity detector comprises a filter for filtering the combined audio.

5. The noise reducing audio receiving system of claim 1 wherein the beamformer comprises an array processor for filtering signals from each of the microphone elements.

6. The noise reducing audio receiving system of claim 5 wherein the array processor uses the select filter coefficients.

7. The noise reducing audio receiving system of claim 5 wherein the voice activity detector comprises an adaptive voice activity detector.

8. The noise reducing audio receiving system of claim 7 wherein the correlation estimator up dates the array processor using the received audio signal in the absence of speech in the received audio signal.

9. The noise reducing audio receiving system of claim 8 wherein the array processor uses the select filter coefficients.

10. The noise reducing audio receiving system of claim 1 wherein the correlation estimator develops a noise spatial correlation matrix in the absence of speech in the received audio signal.

11. The noise reducing audio receiving system of claim 10 wherein the correlation estimator calculates the select filter coefficients using the noise spatial correlation matrix and a function representing propagation channel between a user and the microphone elements.

12. A noise reduction apparatus comprising:
a microphone array comprising a plurality of microphone elements for receiving an audio signal;
a processing system connected to the microphone array to develop an estimate of a speech signal, the processing system being programmed to implement an array filter, a voice activity detector and a correlation function, wherein
the array filter is operable to filter noise in accordance with select filter coefficients,
the voice activity detector combines audio from the microphone elements and detects presence or absence of speech in the received audio signal, and
the correlation function updates the select filter coefficients using the received audio signal in the absence of speech in the received audio signal.

13. The noise reduction apparatus of claim 12 wherein the array filter implements a filter for each microphone element and the speech signal estimate is a superposition of signals from the filters.

14. The noise reduction apparatus of claim 12 wherein the voice activity detector comprises a filter for filtering the combined audio.

15. The noise reduction apparatus of claim 12 wherein the voice activity detector comprises an array filter for filtering signals from each of the microphone elements.

16. The noise reduction apparatus of claim 15 wherein the array filter uses the select filter coefficients.

17. The noise reduction apparatus of claim 15 wherein the voice activity detector comprises an adaptive voice activity detector.

18. The noise reduction apparatus of claim 17 wherein the correlation function updates the array filter using the received audio signal in the absence of speech in the received audio signal.

19. The noise reduction apparatus of claim 12 wherein the correlation function develops a noise spatial correlation matrix in the absence of speech in the received audio signal.

20. The noise reduction apparatus of claim 19 wherein the correlation function calculates the select filter coefficients using the noise spatial correlation matrix and a function representing propagation channel between a user and the microphone elements,

21. A mobile terminal used in a mobile communications system comprising:
a microphone array comprising a plurality of microphone elements for receiving an audio signal;
an array filter connected to the microphone array for filtering noise in accordance with select filter coefficients to develop an estimate of a speech signal;
a transmitter for transmitting wireless signals responsive to the speech signal estimate;
a voice activity detector connected to the microphone array and comprising a beamformer for combining audio from the microphone elements and a detector for detecting presence or absence of speech in the combined audio;
a correlation estimator operatively connected to the microphone array, the voice activity detector and the array filter, the correlation estimator updating the select filter coefficients using the received audio signal in the absence of speech in the received audio signal.

22. The mobile terminal of claim 21 wherein the array filter comprises a filter for each microphone element and a summer and the speech signal estimate is a superposition of signal outputs from the filters.

23. The mobile terminal of claim 21 wherein the beamformer comprises a summer for summing signals from each of the microphone elements.

24. The mobile terminal of claim 23 wherein the voice activity detector comprises a filter for filtering the combined audio.

25. The mobile terminal of claim 21 wherein the beamformer comprises an array processor for filtering signals from each of the microphone elements.

26. The mobile terminal of claim 25 wherein the array processor uses the select filter coefficients.

27. The mobile terminal of claim 25 wherein the voice activity detector comprises an adaptive voice activity detector.

28. The mobile terminal of claim 27 wherein the correlation estimator updates the array processor using the received audio signal in the absence of speech in the received audio signal.

29. The mobile terminal of claim 28 wherein the array processor uses the select filter coefficients.

30. The mobile terminal of claim 21 wherein the correlation estimator develops a noise spatial correlation matrix in the absence of speech in the received audio signal.

31. The mobile terminal of claim 30 wherein the correlation estimator calculates the select filter coefficients using the noise spatial correlation matrix and a function representing propagation channel between a user and the microphone elements,

32. A method of reducing noise in an audio receiving system comprising:
receiving a plurality of audio signals each having different spatial properties;
filtering noise from the plurality of audio signals in accordance with select filter coefficients to develop an estimate of a speech signal;
combining the received audio signals to develop a combined signal;
detecting presence or absence of speech in the combined signal; and
updating the select filter coefficients using the plurality of received audio signals in the absence of speech in the combined signal.

33. The method of claim 32 wherein filtering noise from the plurality of audio signals in accordance with select filter coefficients to develop an estimate of a speech signal comprises providing a filter for each audio signal and the speech signal estimate is a superposition of filtered audio signals.

34. The method of claim 32 wherein combining the received audio signals to develop a combined signal comprises summing the plurality of audio signals.

35. The method of claim 34 wherein detecting presence or absence of speech in the combined signal comprises providing a filter for filtering the combined signal.

36. The method of claim 32 wherein combining the received audio signals to develop a combined signal comprises providing an array processor for filtering each of the audio signals.

37. The method of claim 36 wherein the array processor uses the select filter coefficients.

38. The method of claim 37 further comprising updating the array processor using the plurality of received audio signals in the absence of speech in the combined signal.

39. The method of claim 38 wherein the array processor uses the select filter coefficients.

40. The method of claim 32 wherein updating the select filter coefficients using the plurality of received audio signals in the absence of speech in the combined signal comprises developing a noise spatial correlation matrix in the absence of speech in the combined signal.

41. The method of claim 40 wherein updating the select filter coefficients using the plurality of received audio signals in the absence of speech in the combined signal comprises calculating the select filter coefficients using the noise spatial correlation matrix and a function representing propagation channel between a user and the microphone elements,
